(19) United States
(12) Patent Application Publication
(10) Pub. No.: US 2006/0109986 A1
(43) Pub. Date: May 25, 2006

(54) Apparatus and method to generate virtual 3D sound using asymmetry and recording medium storing program to perform the method

(76) Inventor: Byeong-seob Ko, Suwon-si (KR)

Correspondence Address: STANZIONE & KIM, LLP, 919 18TH STREET, N.W., SUITE 440, WASHINGTON, DC, 20006, US

(21) Appl. No.: 11/099,446

(22) Filed: Apr. 6, 2005

(30) Foreign Application Priority Data
Nov. 24, 2004 (KR) 2004-97019

(51) Int. Cl. H04R 5/00

(52) U.S. Cl. 381/17

(57) ABSTRACT

A virtual 3D sound generating apparatus and method, which can be easily applied to portable devices such as headphones and earphones. The method includes delaying a first input signal for a first time corresponding to a distance between a first virtual sound source and the left ear of a virtual listener, and delaying a second input signal for a second time corresponding to a distance between a second virtual sound source and the right ear of the virtual listener. Accordingly, a maximum virtual 3D sound effect can be obtained using a minimum number of elements by delaying signals for different amounts of time to simulate geometrical asymmetry of a real listening space.

### CROSS-REFERENCE TO RELATED APPLICATIONS

This application claims the priority of Korean Patent Application No. 2004-97019, filed on Nov. 24, 2004, in the Korean Intellectual Property Office, the disclosure of which is incorporated herein in its entirety by reference.

### BACKGROUND OF THE INVENTION

1. Field of the Invention

The present general inventive concept relates to an apparatus and method to generate a virtual 3-dimensional (3D) sound, and more particularly, to a virtual 3D sound generating apparatus and method which can be easily applied to portable devices such as headphones and earphones.

2. Description of the Related Art

When listening to music using headphones or earphones, since a sound image is located inside the head, the listening experience is not as good as when listening to music using speakers. For example, regular headphones or earphones do not give the listener the sensation of being surrounded by the music in an actual listening space. An example of conventional technology designed to produce 3-dimentional audio effects through headphones or earphones is disclosed in Japanese Patent Publication No. 1991-250900. The following paragraphs point out problems associated with such conventional technology.

FIG. 1 is a conceptual diagram illustrating a conventional virtual 3D sound generating method.

Referring to FIG. 1, in the conventional virtual 3D sound generating method, a virtual 3D sound is generated by assuming two virtual sound sources 11 and 12, and a virtual listener 13, and simulating 8 signals DLL, DRR, DLR, DRL, RLL, RRR, RLR, and RRL transferred from the virtual sound sources 11 and 12 to .the virtual listener 13 with respect to two input signals.

FIG. 2 is a block diagram of a conventional virtual 3D sound generating apparatus.

Referring to FIG. 2, the conventional virtual 3D sound generating apparatus includes four filters 201, 204, 207, and 209, two reflected sound generators 203 and 206, four delay units 202, 205, 208, and 210, two adders 211 and 212, and two amplifiers 213 and 214.

The two filters 201 and 209 filter signals input from a video deck 15 in order to generate cross-talk signals, i.e., signals DLR and DRL. The two delay units 202 and 210 delay the signals filtered by the two filters 201 and 209 for the time it takes signals output from the virtual sound sources 11 and 12 to arrive at the left and right ears of the virtual listener 13.

The reflected sound generators 203 and 206 generate echoes, i.e., signals RLL and RRR, which are generated by a listening space when listening through speakers. The other two filters 204 and 207 filter the signals generated by the reflected sound generators 203 and 206 in order to generate cross-talk signals, i.e., signals RLR and RRL, of the echoes. The other two delay units 205 and 208 delay the signals filtered by the other two filters 204 and 207 for the time it takes the signals output from the virtual sound sources 11 and 12 to be reflected and arrive at the left and right ears of the virtual listener 13.

In the conventional virtual 3D sound generating apparatus, the two filters 201 and 209 perform higher order finite impulse response (FIR) filtering in order to generate the cross-talk signals, the reflected sound generators 203 and 206 perform higher order FIR filtering and all-pass filtering in order to generate the echoes, and the other two filters 204 and 207 perform the higher order FIR filtering in order to generate the cross-talk signals of the echoes. However, higher order FIR filtering and all-pass filtering are not suitable for portable devices such as headphones and earphones because they require a large amount of computation.

Besides the conventional technology described above, there are methods of using a head-related transfer function (HRTF) to generate a finer virtual 3D sound. However, these methods also require a large amount of computation and thus are not suitable for portable devices such as headphones and earphones.

### SUMMARY OF THE INVENTION

The present general inventive concept provides a method and apparatus that maximize virtual 3D sound effects using a minimum number of elements. The method and apparatus can be easily applied to portable devices such as headphones and earphones, so-called performance-limited devices. The present general inventive concept also provides a recording medium storing a computer program to perform the method.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept are achieved by providing a virtual 3D sound generating method including delaying at least one signal for periods of time corresponding to distances between at least one virtual sound source and the left and right ears of a virtual listener.

The foregoing and/or other aspects and advantages of the present general inventive concept may also be achieved by providing a virtual 3D sound generating apparatus including a delay unit for delaying at least one signal for periods of time corresponding to distances between at least one virtual sound source and the left and right ears of a virtual listener.

The foregoing and/or other aspects and advantages of the present general inventive concept may also be achieved by providing a computer-readable recording medium having recorded thereon a computer program for performing the virtual 3D sound generating method.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a conceptual diagram illustrating a conventional virtual 3D sound generating method;

FIG. 2 is a block diagram of a conventional virtual 3D sound generating apparatus;

FIG. 3 is a conceptual diagram illustrating a virtual 3D sound generating method according to an embodiment of the present general inventive concept;

FIG. 4 is a block diagram of a virtual 3D sound generating apparatus according to an embodiment of the present general inventive concept;

FIG. 5 is a circuit diagram of the virtual 3D sound generating apparatus shown in FIG. 4;

FIG. 6 is a circuit diagram of a first order IIR filter used for the virtual 3D sound generating apparatus shown in FIG. 5;

FIG. 7 is a circuit diagram of a first order FIR filter used for the virtual 3D sound generating apparatus shown in FIG. 5;

FIG. 8 is a circuit diagram of a reverberant sound simulator used for the virtual 3D sound generating apparatus shown in FIG. 5;

FIG. 9 is an equivalent circuit diagram of the virtual 3D sound generating apparatus shown in FIG. 5;

FIG. 10 illustrates the configuration of a 5-channel-input and 2-channel-output device based on the virtual 3D sound generating apparatus shown in FIG. 4; and

FIGS. 11A-11B, 12, and 13 are flowcharts illustrating a virtual 3D sound generating method according to an embodiment of the present general inventive concept.

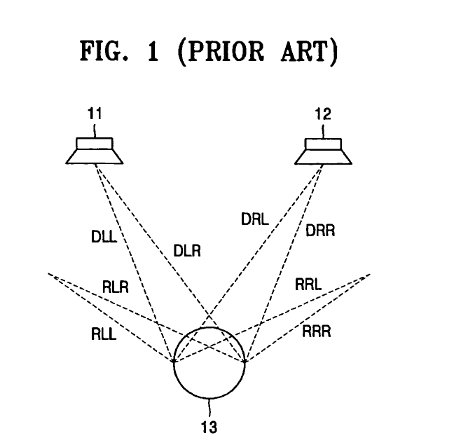

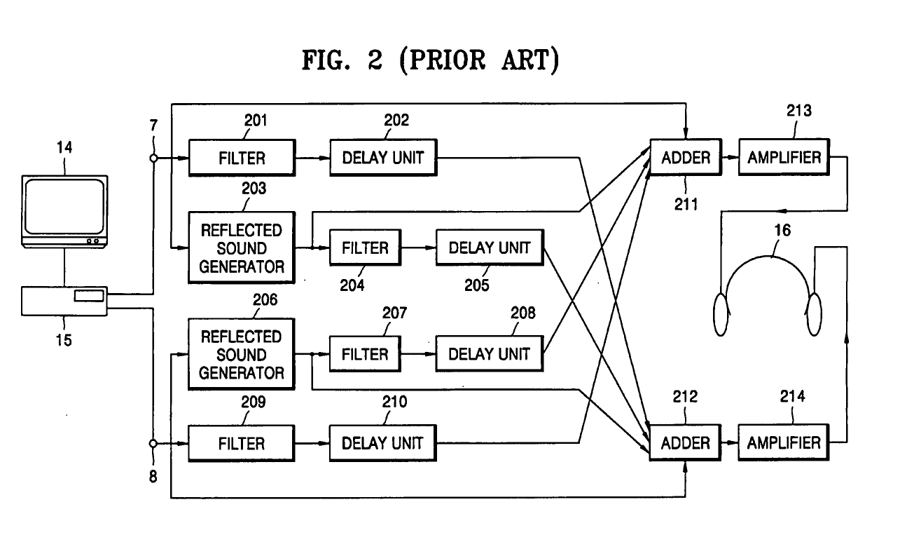

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

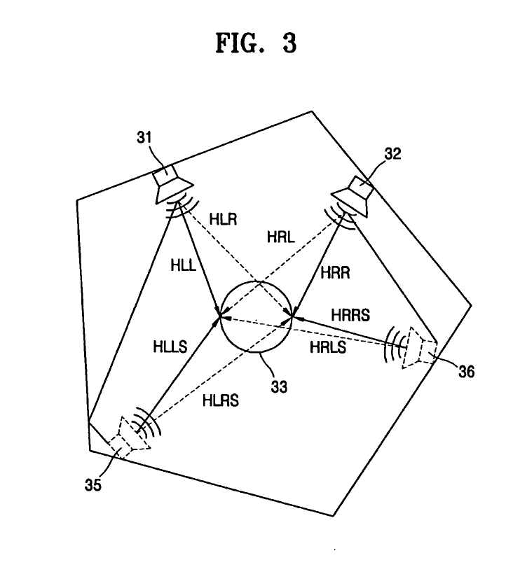

FIG. 3 is a conceptual diagram illustrating a virtual 3D sound generating method according to an embodiment of the present general inventive concept.

Referring to FIG. 3, in the virtual 3D sound generating method, a virtual 3D sound is generated by assuming two virtual sound sources 31 and 32 and a virtual listener 33 and simulating 8 signals HLL, HRR, HLR, HRL, HLLS, HRRS, HLRS, and HRLS transferred from the virtual sound sources 31 and 32 to the virtual listener 33 with respect to two input signals.

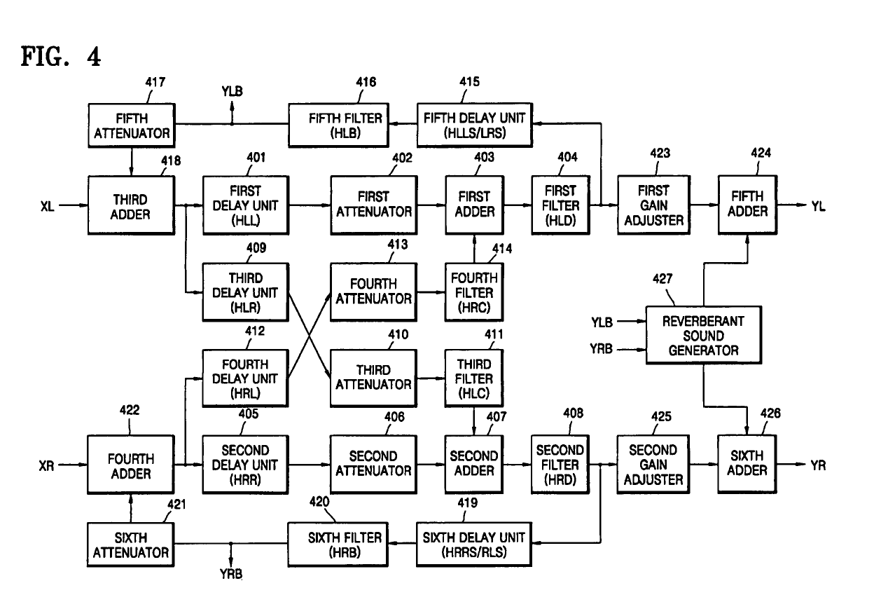

FIG. 4 is a block diagram of a virtual 3D sound generating apparatus according to an embodiment of the present general inventive concept.

Referring to FIG. 4, the virtual 3D sound generating apparatus includes a first delay unit 401, a first attenuator 402, a first adder 403, a first filter 404, a second delay unit 405, a second attenuator 406, a second adder 407, a second filter 408, a third delay unit 409, a third attenuator 410, a third filter 411, a fourth delay unit 412, a fourth attenuator 413, a fourth filter 414, a fifth delay unit 415, a fifth filter 416, a fifth attenuator 417, a third adder 418, a sixth delay unit 419, a sixth filter 420, a sixth attenuator 421, a fourth adder 422, a first gain adjuster 423, a fifth adder 424, a second gain adjuster 425, a sixth adder 426, and a reflected (reverberant) sound generator 427.

The first delay unit 401 delays a left channel input signal XL for a time period corresponding to a distance between the left virtual sound source 31 and the left ear of the virtual listener 33. That is, the first delay unit 401 delays the left channel input signal XL for the time it takes a signal output from the left virtual sound source 31 to arrive at the left ear of the virtual listener 33. The first delay unit 401 can be realized by a delay filter whose transfer function is HLL(z).

The second delay unit 405 delays a right channel input signal XR for a time period corresponding to a distance between the right virtual sound source 32 and the right ear of the virtual listener 33. That is, the second delay unit 405 delays the right channel input signal XR for the time it takes a signal output from the right virtual sound source 32 to arrive at the right ear of the virtual listener 33. The second delay unit 405 can be realized by a delay filter whose transfer function is HRR(z).

The third delay unit 409 delays the left channel input signal XL for a time period corresponding to a distance between the left virtual sound source 31 and the right ear of the virtual listener 33. That is, the third delay unit 409 delays the left channel input signal XL for the time it takes the signal output from the left virtual sound source 31 to arrive at the right ear of the virtual listener 33. The third delay unit 409 can be realized by a delay filter whose transfer function is HLR(z). Here, the signal arriving at the right ear of the virtual listener 33 from the left virtual sound source 31 corresponds to a cross-talk signal.

The fourth delay unit 412 delays the right channel input signal XR for a time period corresponding to a distance between the right virtual sound source 32 and the left ear of the virtual listener 33. That is, the fourth delay unit 412 delays the right channel input signal XR for the time it takes the signal output from the right virtual sound source 32 to arrive at the left ear of the virtual listener 33. The fourth delay unit 412 can be realized by a delay filter whose transfer function is HRL(z). Here, the signal arriving at the left ear of the virtual listener 33 from the right virtual sound source 32 corresponds to the cross-talk signal.

The first attenuator 402 attenuates the signal delayed by the first delay unit 401 by an attenuation factor corresponding to the distance between the left virtual sound source 31 and the left ear of the virtual listener 33. This simulates the attenuation of sound propagating through the air from the left virtual sound source 31 to the left ear of the virtual listener 33.

The second attenuator 406 attenuates the signal delayed by the second delay unit 405 by a magnitude corresponding to the distance between the right virtual sound source 32 and the right ear of the virtual listener 33. This simulates the attenuation of sound propagating through the air from the right virtual sound source 32 to the right ear of the virtual listener 33.

The third attenuator 410 attenuates the signal delayed by the third delay unit 409 by a magnitude corresponding to the distance between the left virtual sound source 31 and the right ear of the virtual listener 33. This simulates the attenuation of sound propagating through the air from the left virtual sound source 31 to the right ear of the virtual listener 33.

The fourth attenuator 413 attenuates the signal delayed by the fourth delay unit 412 by a magnitude corresponding to the distance between the right virtual sound source 32 and the left ear of the virtual listener 33. This simulates the attenuation of sound propagating through the air from the right virtual sound source 32 to the left ear of the virtual listener 33.

The third filter 411 filters out a high-frequency band of the signal attenuated by the third attenuator 410 to simulate high-frequency attenuation caused by diffraction at the head of the virtual listener 33. The third filter 411 can be realized by a low-pass filter whose transfer function is HLC(z).

The fourth filter 414 filters out a high-frequency band of the signal attenuated by the fourth attenuator 413 to simulate high-frequency attenuation caused by diffraction at the head of the virtual listener 33. The fourth filter 414 can be realized by a low-pass filter whose transfer function is HRC(z).

The first adder 403 adds the signal filtered by the fourth filter 414 and the signal attenuated by the first attenuator 402.

The second adder 407 adds the signal filtered by the third filter 411 and the signal attenuated by the second attenuator 406.

The first filter 404 filters out a high-frequency band of a signal output by the first adder 403 to simulate high-frequency attenuation due to a lower spatial transmittance of high frequencies over the distance between the left virtual sound source 31 and the left ear of the virtual listener 33. The first filter 404 can be realized by a low-pass filter whose transfer function is HLD(z).

The second filter 408 filters out a high-frequency band of the signal output by the second adder 407 to simulate high-frequency attenuation due to a lower spatial transmittance of high frequencies over the distance between the right virtual sound source 32 and the right ear of the virtual listener 33. The second filter 408 can be realized by a low-pass filter whose transfer function is HRD(z).

The fifth delay unit 415 delays the signal filtered by the first filter 404 for a time period corresponding to a distance between the left virtual sound source 31 and a left reflection surface 35 and a distance between the left reflection surface 35 and the left ear of the virtual listener 33. That is, the fifth delay unit 415 delays the signal filtered by the first filter 404 for the time it takes the signal output from the left virtual sound source 31 to be reflected from a left wall and arrive at the left ear of the virtual listener 33. Here, the fifth delay unit 415 simultaneously delays the signal filtered by the first filter 404 for times obtained by subtracting the delay time of the first delay unit 401 from the total times taken for the signal output from the left virtual sound source 31 to be reflected from the left wall and arrive at each of the left and right ears of the virtual listener 33. In this manner, in the present embodiment, in order to reduce the number of elements required to generate the virtual 3D sound as much as possible, elements like the first delay unit 401 are repeatedly used. The fifth delay unit 415 can be realized by a delay filter whose transfer function is HLLS/LRS(z).

The fifth filter 416 filters out a high-frequency band of the signal delayed by the fifth delay unit 415 to simulate high-frequency attenuation due to a lower spatial transmittance of high frequencies over the distance between the left virtual sound source 31 and the left reflection surface 35 and the distance between the left reflection surface 35 and the left ear of the virtual listener 33. The fifth filter 416 can be realized by a low-pass filter whose transfer function is HLB(z).

The fifth attenuator 417 attenuates the signal filtered by the fifth filter 416 by an attenuation factor corresponding to the distance between the left virtual sound source 31 and the left reflection surface 35 and the distance between the left reflection surface 35 and the left ear of the virtual listener 33. This simulates the attenuation of sound propagating through the air from the left virtual sound source 31 to the left reflection surface 35 and then to the left ear of the virtual listener 33.

The third adder 418 adds the signal attenuated by the fifth attenuator 417 and the left channel input signal XL.

The sixth delay unit 419 delays the signal filtered by the second filter 408 for a time period corresponding to a distance between the right virtual sound source 32 and a right reflection surface 36 and a distance between the right reflection surface 36 and the right ear of the virtual listener 33. That is, the sixth delay unit 419 delays the signal filtered by the second filter 408 for the time it takes the signal output from the right virtual sound source 32 to be reflected from a right wall and arrive at the right ear of the virtual listener 33. Here, the sixth delay unit 419 simultaneously delays the signal filtered by the second filter 408 for times obtained by subtracting the delay time of the second delay unit 405 from the total times taken for the signal output from the right virtual sound source 32 to be reflected from the right wall and arrive at each of the right and left ears of the virtual listener 33. In this manner, in the present embodiment, in order to reduce the number of elements required to generate the virtual 3D sound as much as possible, elements like the second delay unit 405 are repeatedly used. The sixth delay unit 419 can be realized by a delay filter whose transfer function is HRRS/RLS(z).

The sixth filter 420 filters out a high-frequency band of the signal delayed by the sixth delay unit 419 to simulate high-frequency attenuation due to a lower spatial transmittance of high frequencies over the distance between the right virtual sound source 32 and the right reflection surface 36 and the distance between the right reflection surface 36 and the right ear of the virtual listener 33. The sixth filter 420 can be realized by a low-pass filter whose transfer function is HRB(z).

The sixth attenuator 421 attenuates the signal filtered by the sixth filter 420 by an attenuation factor corresponding to the distance between the right virtual sound source 32 and the right reflection surface 36 and the distance between the right reflection surface 36 and the right ear of the virtual listener 33. This simulates the attenuation of sound propagating through the air from the right virtual sound source 32 to the right reflection surface 36 and then to the right ear of the virtual listener 33.

The fourth adder 422 adds the signal attenuated by the sixth attenuator 421 and the right channel input signal XR.

The first gain adjuster 423 adjusts a gain of the signal filtered by the first filter 404 to be suitable to synthesize the signal filtered by the first filter 404 with a reverberant signal of the left channel input signal XL.

The second gain adjuster 425 adjusts a gain of the signal filtered by the second filter 408 to be suitable to synthesize the signal filtered by the second filter 408 with a reverberant signal of the right channel input signal XR.

The reverberant sound generator 427 generates a left reverberant sound and a right reverberant sound from the signal filtered by the fifth filter 416 and the signal filtered by the sixth filter 420.

The fifth adder 424 adds the left reverberant sound generated by the reverberant sound generator 427 and the signal output from the first gain adjuster 423. The signal output from the fifth adder 424 corresponds to a left 3D sound signal YL which has been subjected to time delays based on the distances between the virtual sound sources 31 and 32 and the virtual listener 33, amplitude attenuation, and high-frequency attenuation.

The sixth adder 426 adds the right reverberant sound generated by the reverberant sound generator 427 to the signal output from the second gain adjuster 425. The signal output from the sixth adder 426 corresponds to a right 3D sound signal YR which has been subjected to time delays based on the distances between the virtual sound sources 31 and 32 and the virtual listener 33, amplitude attenuation, and high-frequency attenuation.

In a real listening space, there is not perfect geometrical symmetry between left and right speakers and the left and right ears of the listener. Considering this point, in the present embodiment, the first delay unit 401, the second delay unit 405, the third delay unit 409, the fourth delay unit 412, the fifth delay unit 415, and the sixth delay unit 419 delay the signals by different times based on geometrical asymmetry between the left virtual sound source 31, the virtual listener 33 and the right virtual sound source 32. In other words, the transfer functions HLL(z), HRR(z), HLR(z), HRL(z), HLLS/LRS(z), and HRRS/RLS(z) are different from each other. In the present embodiment, virtual 3D sound effects can be maximized using a minimum number of elements by simulating unequal distances from the virtual listener 33 to the left virtual sound source 31 and the right virtual sound source 32.

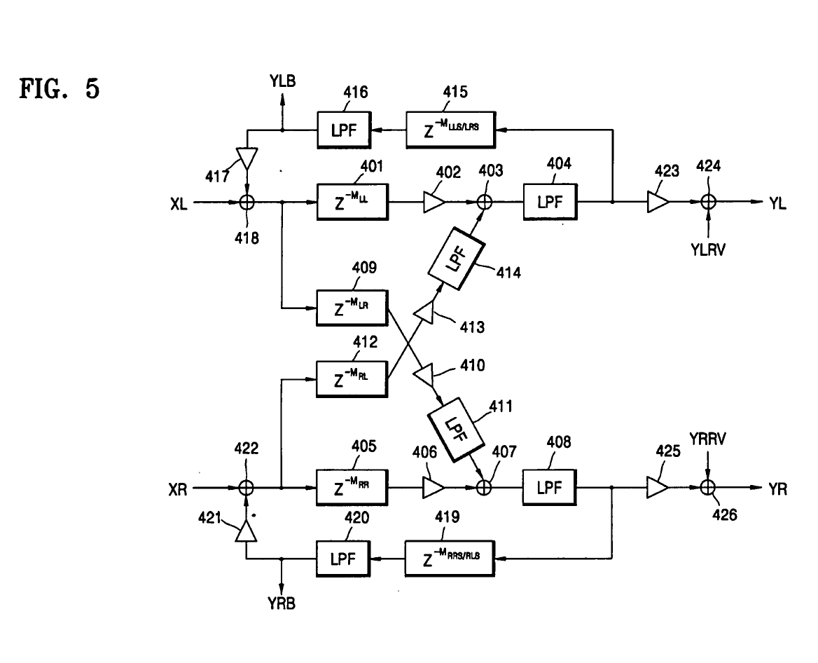

FIG. 5 is a circuit diagram of the virtual 3D sound generating apparatus shown in FIG. 4.

Referring to FIG. 5, the virtual 3D sound generating apparatus shown in FIG. 4 can be realized using three basic digital filter elements, i.e., adders, multipliers, and delay elements.

The first delay unit 401 can be realized using a delay filter whose transfer function is HLL(z)=Z^{-M}_{LL}. The second delay unit 405 can be realized using a delay filter whose transfer function is HRR(z)=Z^{-M}_{RR}. The third delay unit 409 can be realized using a delay filter whose transfer function is HLR(z)=Z^{-M}_{LR}. The fourth delay unit 412 can be realized using a delay filter whose transfer function is HRL(z)=Z^{-M}_{RL}. The fifth delay unit 415 can be realized using a delay filter whose transfer function is HLLS/LRS(z)=Z^{-M}_{LLS/LRS}. The sixth delay unit 419 can be realized using a delay filter whose transfer function is HRRS/RLS(z)=Z^{-M}_{RRS/RLS}.

The first attenuator 402, the second attenuator 406, the third attenuator 410, the fourth attenuator 413, the fifth attenuator 417, the sixth attenuator 421, the first adder 403, the second adder 407, the third adder 418, the fourth adder 422, the fifth adder 424, the sixth adder 426, the first gain adjuster 423, and the second adjuster 425 can be realized using multipliers.

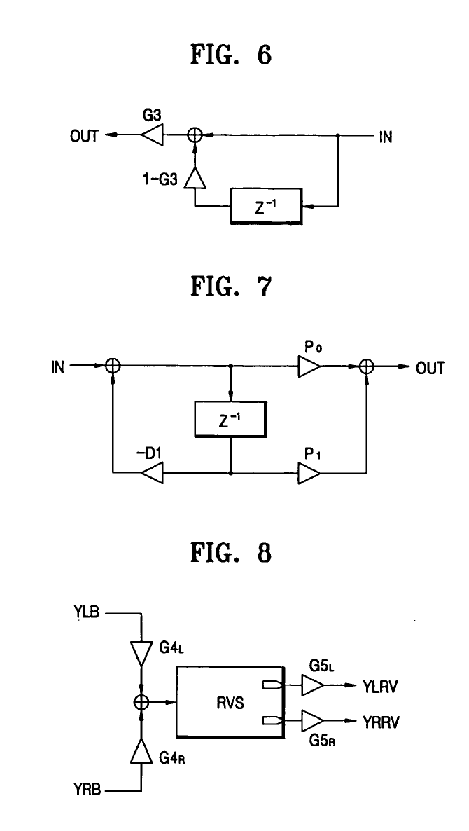

The third filter 411 can be realized using a low-pass filter, shown in FIG. 6, whose transfer function is HLC(z). The fourth filter 414 can be realized using a low-pass filter of FIG. 6 whose transfer function is HRC(z). The fifth filter 416 can be realized using a low-pass filter of FIG. 6 whose transfer function is HLB(z). The sixth filter 420 can be realized using a low-pass filter of FIG. 6 whose transfer function is HRB(z).

FIG. 6 is a circuit diagram of a first order infinite impulse response (IIR) filter used for the virtual 3D sound generating apparatus shown in FIG. 5.

Referring to FIG. 6, the first order IIR filter used for the virtual 3D sound generating apparatus shown in FIG. 5 includes a first order delay element, an adder, and two multipliers. Since the third filter 411, the fourth filter 414, the fifth filter 416, and the sixth filter 420 can be realized using simple first order IIR filters, the virtual 3D sound generating apparatus according to the present embodiment can be applied to portable devices.

The first filter 404 can be realized using a low-pass filter, shown in FIG. 7, whose transfer function is HLD(z). The second filter 408 can be realized using a low-pass filter of FIG. 7 whose transfer function is HRD(z).

FIG. 7 is a circuit diagram of a first order finite impulse response (FIR) filter used for the virtual 3D sound generating apparatus shown in FIG. 5.

Referring to FIG. 7, the first order FIR filter used for the virtual 3D sound generating apparatus shown in FIG. 5 includes a first order delay element, two adders, and three multipliers. Since the first filter 404 and the second filter 408 can be realized using simple first order FIR filters, the virtual 3D sound generating apparatus according to the present embodiment can be applied to portable devices.

FIG. 8 is a circuit diagram of a reverberant sound simulator used for the virtual 3D sound generating apparatus shown in FIG. 5.

The reverberant sound generator 427 generates reverberant sounds using the simple reverberant sound simulator shown in FIG. 8.

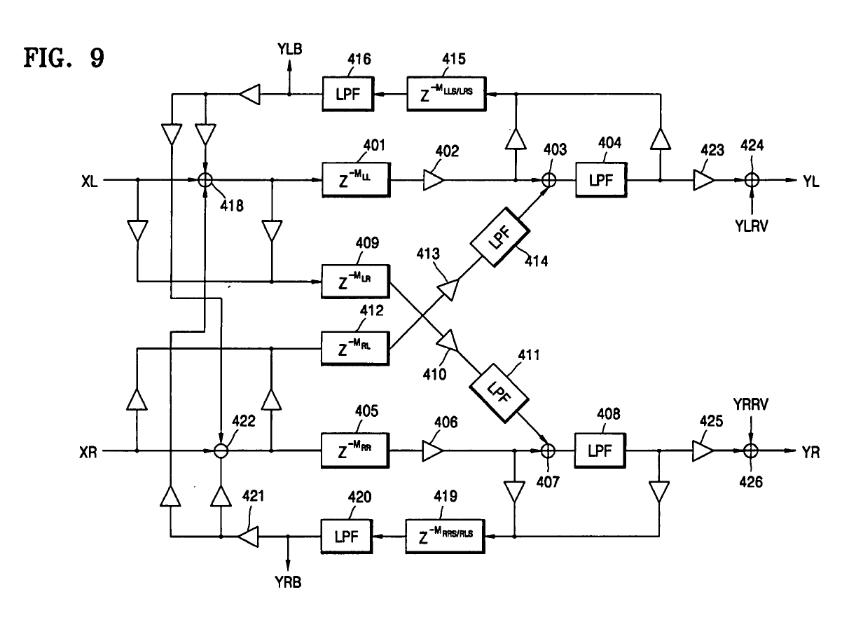

FIG. 9 is an equivalent circuit diagram of the virtual 3D sound generating apparatus shown in FIG. 5.

Referring to FIG. 9, in the apparatus shown in FIG. 9, a plurality of multipliers are added to the virtual 3D sound generating apparatus shown in FIG. 5, as a modification to the configuration of FIG. 5. It will be understood by those skilled in the art that the configuration of FIG. 9 is equivalent to the configuration of FIG. 5.

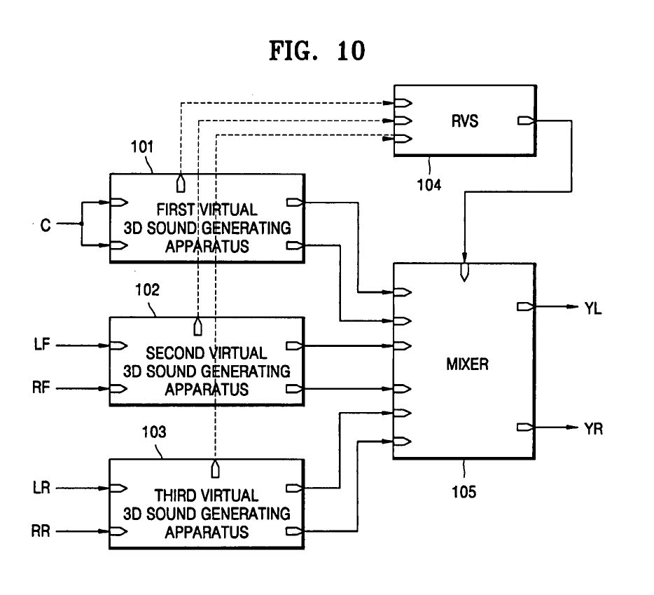

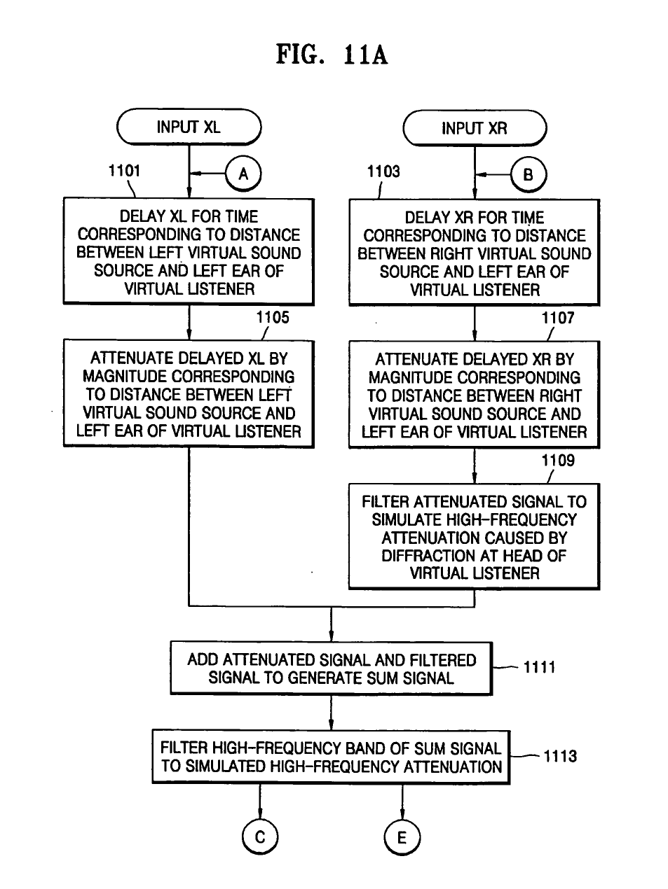

FIG. 10 is a circuit diagram of a 5-channel-input and 2-channel-output device based on the virtual 3D sound generating apparatus shown in FIG. 4.

Referring to FIG. 10, the 5-channel-input and 2-channel-output device based on the virtual 3D sound generating apparatus shown in FIG. 4 includes a first virtual 3D sound generating apparatus 101, a second virtual 3D sound generating apparatus 102, a third virtual 3D sound generating apparatus 103, a reverberant sound simulator 104, and a mixer 105.

The first virtual 3D sound generating apparatus 101 has the same configuration as the virtual 3D sound generating apparatus shown in FIG. 4 and generates two output signals from a single center signal. This is an example of how a mono signal can be up-mixed into a pseudo stereo signal by using the virtual 3D sound generating apparatus shown in FIG. 4.

The second virtual 3D sound generating apparatus 102 has the same configuration as the virtual 3D sound generating apparatus shown in FIG. 4 and generates two output signals from a left-front signal and a right-front signal.

The third virtual 3D sound generating apparatus 103 has the same configuration as the virtual 3D sound generating apparatus shown in FIG. 4 and generates two output signals from a left-rear signal and a right-rear signal.

The reverberant sound simulator 104 generates a reverberant sound from the signals generated by the first virtual 3D sound generating apparatus 101, the second virtual 3D sound generating apparatus 102, and the third virtual 3D sound generating apparatus 103.

The mixer 105 generates two output signals YL and YR by down-mixing the signals generated by the first virtual 3D sound generating apparatus 101, the second virtual 3D sound generating apparatus 102, and the third virtual 3D sound generating apparatus 103, and the signal generated by the reverberant sound simulator 104.

The 5-channel-input and 2-channel-output device shown in FIG. 10 corresponds to an example of application devices based on the virtual 3D sound generating apparatus shown in FIG. 4. Other application devices, such as, N-channel input M-channel output devices, can be easily derived based on the virtual 3D sound generating apparatus shown in FIG. 4 by those skilled in the art.

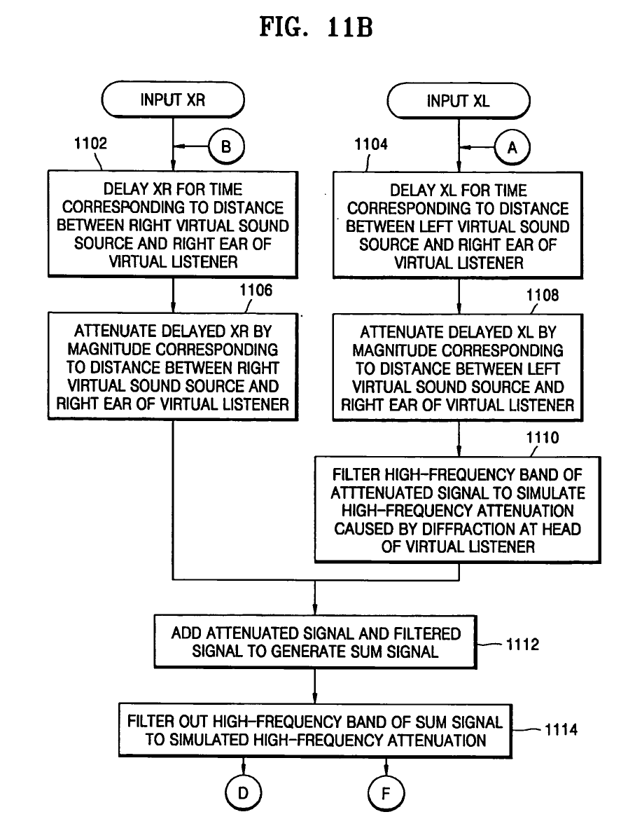

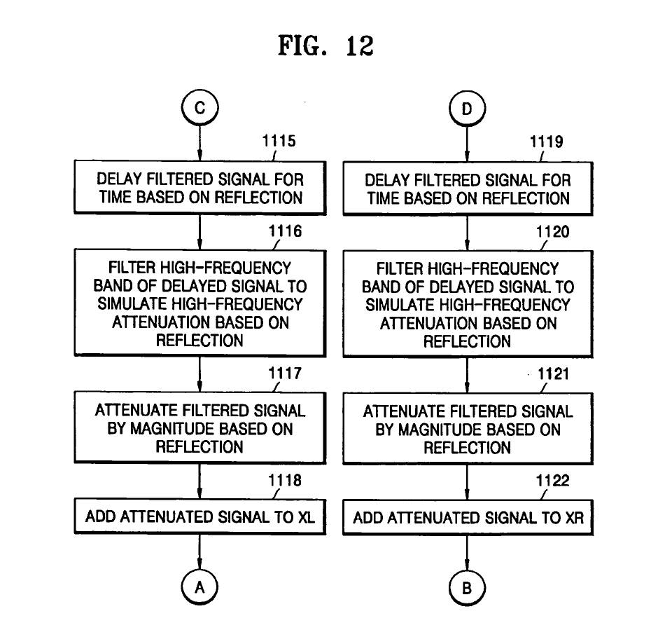

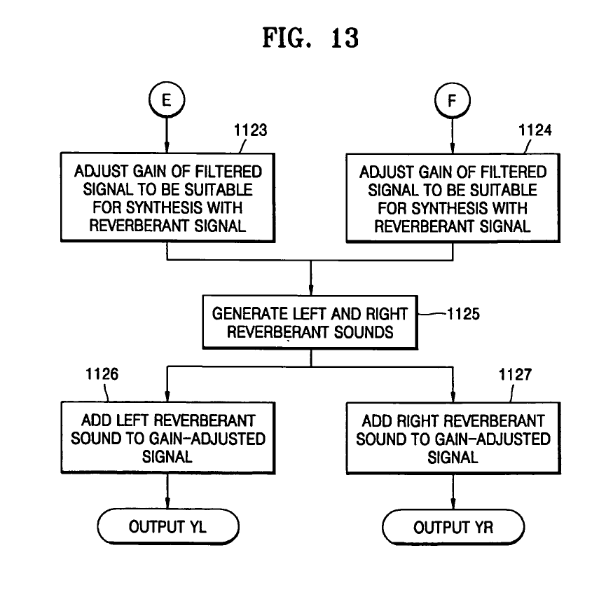

FIGS. 11A-11B, 12, and 13 are flowcharts illustrating a virtual 3D sound generating method according to an embodiment of the present general inventive concept.

Referring to FIGS. 11A-11B, 12, and 13, the virtual 3D sound generating method includes the operations described below, which are processed in sequential order by the virtual 3D sound generating apparatus described above and shown in FIG. 4.

In operation 1101, the virtual 3D sound generating apparatus delays the left channel input signal XL for a time corresponding to the distance between the left virtual sound source 31 and the left ear of the virtual listener 33.

In operation 1102, the virtual 3D sound generating apparatus delays the right channel input signal XR for a time corresponding to the distance between the right virtual sound source 32 and the right ear of the virtual listener 33.

In operation 1103, the virtual 3D sound generating apparatus delays the right channel input signal XR for a time corresponding to the distance between the right virtual sound source 32 and the left ear of the virtual listener 33.

In operation 1104, the virtual 3D sound generating apparatus delays the left channel input signal XL for a time corresponding to the distance between the left virtual sound source 31 and the right ear of the virtual listener 33.

In operation 1105, the virtual 3D sound generating apparatus attenuates the signal delayed in operation 1101 by an amount corresponding to the distance between the left virtual sound source 31 and the left ear of the virtual listener 33.

In operation 1106, the virtual 3D sound generating apparatus attenuates the signal delayed in operation 1102 by an amount corresponding to the distance between the right virtual sound source 32 and the right ear of the virtual listener 33.

In operation 1107, the virtual 3D sound generating apparatus attenuates the signal delayed in operation 1103 by an amount corresponding to the distance between the right virtual sound source 32 and the left ear of the virtual listener 33.

In operation 1108, the virtual 3D sound generating apparatus attenuates the signal delayed in operation 1104 by an amount corresponding to the distance between the left virtual sound source 31 and the right ear of the virtual listener 33.

In operation 1109, the virtual 3D sound generating apparatus filters out a high-frequency band of the signal attenuated in operation 1107 to simulate high-frequency attenuation caused by diffraction at the head of the virtual listener 33.

In operation 1110, the virtual 3D sound generating apparatus filters out a high-frequency band of the signal attenuated in operation 1108 to simulate high-frequency attenuation caused by diffraction at the head of the virtual listener 33.

In operation 1111, the virtual 3D sound generating apparatus adds the signal filtered in operation 1109 to the signal attenuated in operation 1105.

In operation 1112, the virtual 3D sound generating apparatus adds the signal filtered in operation 1110 to the signal attenuated in operation 1106.

In operation 1113, the virtual 3D sound generating apparatus filters out a high-frequency band of the signal resulting from operation 1111 to simulate high-frequency attenuation occurring when sound waves propagate from the left virtual sound source 31 to the left ear of the virtual listener 33.

In operation 1114, the virtual 3D sound generating apparatus filters out a high-frequency band of the signal resulting from operation 1112 to simulate high-frequency attenuation occurring when sound waves propagate from the right virtual sound source 32 to the right ear of the virtual listener 33.

In operation 1115, the virtual 3D sound generating apparatus delays the signal filtered in operation 1113 for a time corresponding to the distance between the left virtual sound source 31 and the left reflection surface 35 and the distance between the left reflection surface 35 and the left ear of the virtual listener 33.

In operation 1116, the virtual 3D sound generating apparatus filters out a high-frequency band of the signal delayed in operation 1115 to simulate high-frequency attenuation occurring when sound waves travel from the left virtual sound source 31 to the left reflection surface 35 and then to the left ear of the virtual listener 33.

In operation 1117, the virtual 3D sound generating apparatus attenuates the signal filtered in operation 1116 by an amount corresponding to the distance between the left virtual sound source 31 and the left reflection surface 35 and the distance between the left reflection surface 35 and the left ear of the virtual listener 33.

In operation 1118, the virtual 3D sound generating apparatus adds the signal attenuated in operation 1117 to the left channel input signal XL.

In operation 1119, the virtual 3D sound generating apparatus delays the signal filtered in operation 1114 for a time corresponding to the distance between the right virtual sound source 32 and the right reflection surface 36 and the distance between the right reflection surface 36 and the right ear of the virtual listener 33.

In operation 1120, the virtual 3D sound generating apparatus filters out a high-frequency band of the signal delayed in operation 1119 to simulate high-frequency attenuation occurring when sound waves propagate from the right virtual sound source 32 to the right reflection surface 36 and then to the right ear of the virtual listener 33.

In operation 1121, the virtual 3D sound generating apparatus attenuates the signal filtered in operation 1120 by an amount corresponding to the distance between the right virtual sound source 32 and the right reflection surface 36 and the distance between the right reflection surface 36 and the right ear of the virtual listener 33.

In operation 1122, the virtual 3D sound generating apparatus adds the signal attenuated in operation 1121 to the right channel input signal XR.

In operation 1123, the virtual 3D sound generating apparatus adjusts a gain of the signal filtered in operation 1113 to be suitable to synthesize with a reverberant signal of the left channel input signal XL.

In operation 1124, the virtual 3D sound generating apparatus adjusts a gain of the signal filtered in operation 1114 to be suitable to synthesize with a reverberant signal of the right channel input signal XR.

In operation 1125, the virtual 3D sound generating apparatus generates a left reverberant sound and a right reverberant sound from the signal filtered in operation 1116 and the signal filtered in operation 1120.

In operation 1126, the virtual 3D sound generating apparatus adds the left reverberant sound generated in operation 1125 to the signal resulting from operation 1123.

In operation 1127, the virtual 3D sound generating apparatus adds the right reverberant sound generated in operation 1125 to the signal resulting from operation 1124.

The embodiments of the present general inventive concept can be written as computer programs on a computer-readable recording medium and executed by a computer. Examples of such a computer-readable recording medium include magnetic storage media (ROM, floppy disks, hard disks, etc.), optical recording media (CD-ROMs, DVDs, etc.), and carrier waves (transmission over the Internet).

As described above, according to the present general inventive concept, by delaying signals for different lengths of time, in order to simulate the geometrical asymmetry of a real listening space, a sound image is virtually located outside of the head and the listener can have the sensation of being surrounded by the music. That is, a maximum virtual 3D sound effect can be obtained using a minimum number of elements. In particular, unlike conventional apparatuses, a virtual 3D sound generating apparatus can be realized using simple first order IIR filters and first order FIR filters by using a minimum number of elements.

Also, a maximum virtual 3D sound effect can be obtained with far fewer calculations than in a conventional HRTF method since only time delays take into account geometrical asymmetry of a real listening space. The present general inventive concept is expected to be widely used in portable devices such as headphones and earphones, so-called performance- limited devices.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of generating a virtual 3-dimensional (3D) sound from at least one signal, the method comprising:
delaying the at least one signal for time periods corresponding to distances between at least one virtual sound source and left and right ears of a virtual listener.

2. The method of claim 1, wherein the operation of delaying the at least one signal for time periods corresponding to the distances between the at least one virtual sound source and the left and right ears of the virtual listener comprises:
delaying a first input signal of the at least one signal for a first time period corresponding to a distance between a first virtual sound source of the at least one virtual sound source and the left ear of a virtual listener; and
delaying a second input signal of the at least one signal for a second time period corresponding to a distance between a second virtual sound source of the at least one virtual sound source and the right ear of the virtual listener.

3. The method of claim 2, wherein the first time period and the second time period are different from each other due the first and second virtual sound sources being at different distances from the virtual listener.

4. The method of claim 2, further comprising:
delaying the first input signal for a third time period corresponding to a distance between the first virtual sound source and the right ear of the virtual listener; and
delaying the second input signal for a fourth time period corresponding to a distance between the second virtual sound source and the left ear of the virtual listener.

5. The method of claim 4, wherein the first time period, the second time period, the third time period, and the fourth time period are all different from each other due to the distances between each of the first and second virtual sound sources and each ear of the virtual listener all being different.

6. The method of claim 4, further comprising:
adding the signal delayed in the operation of delaying the first input signal for a third time period corresponding to a distance between the first virtual sound source and the right ear of the virtual listener to the signal delayed in the operation of delaying the second input signal for a second time period corresponding to a distance between a second virtual sound source and the right ear of a virtual listener; and
adding the signal delayed in the operation of delaying the second input signal for a fourth time period corresponding to a distance between the second virtual sound source and the left ear of the virtual listener to the signal delayed in the operation of delaying the first input signal for a first time period corresponding to a distance between a first virtual sound source and the left ear of the virtual listener.

7. The method of claim 6, further comprising:
delaying the signal resulting from adding the signal delayed in the operation of delaying the second input signal for a fourth time period corresponding to a distance between the second virtual sound source and the left ear of the virtual listener to the signal delayed in the operation of delaying the first input signal for a first time period corresponding to a distance between a first virtual sound source and the left ear of a virtual listener for a fifth time period corresponding to a distance between the first virtual sound source and a first reflection surface and a distance between the first reflection surface and the left ear of the virtual listener; and
delaying the signal resulting from adding the signal delayed in the operation of delaying the first input signal for a third time period corresponding to a distance between the first virtual sound source and the right ear of the virtual listener to the signal delayed in the operation of delaying the second input signal for a second time period corresponding to a distance between a second virtual sound source and the right ear of the virtual listener for a sixth time period corresponding to a distance between the second virtual sound source and a second reflection surface and a distance between the second reflection surface and the right ear of the virtual listener.

8. The method of claim 7, wherein the first time period, the second time period, the third time period, the fourth time period, the fifth time period, and the sixth time period are all different from each other due to geometrical asymmetry in the positioning of the first and second virtual sound sources with respect to the virtual listener.

9. An apparatus to generate a virtual 3-dimensional (3D) sound from at least one signals, the apparatus comprising:
a delay unit to delay the at least one signal for time periods corresponding to distances between at least one virtual sound source and left and right ears of a virtual listener.

10. The apparatus of claim 9, wherein the delay unit comprises:
a first delay unit to delay a first input signal of the at least one signal for a first time period corresponding to a distance between a first virtual sound source of the at least one virtual sound source and the left ear of a virtual listener; and
a second delay unit to delay a second input signal of the at least one signal for a second time period corresponding to a distance between a second virtual sound source of the at least one virtual sound source and the right ear of the virtual listener.

11. The apparatus of claim 10, wherein the first time period and the second time period are different from each other due the first and second virtual sound sources being at different distances from the virtual listener.

12. The apparatus of claim 10, further comprising:
a first attenuator to attenuate the signal delayed by the first delay unit by a first magnitude corresponding to the distance between the first virtual sound source and the left ear of the virtual listener; and
a second attenuator to attenuate the signal delayed by the second delay unit by a second magnitude corresponding to the distance between the second virtual sound source and the right ear of the virtual listener.

13. The apparatus of claim 10, further comprising:
a third delay unit to delay the first input signal for a third time period corresponding to a distance between the first virtual sound source and the right ear of the virtual listener; and
a fourth delay unit to delay the second input signal for a fourth time period corresponding to a distance between the second virtual sound source and the left ear of the virtual listener.

14. The apparatus of claim 13, further comprising:
a third attenuator to attenuate the signal delayed by the third delay unit by a third magnitude corresponding to the distance between the first virtual sound source and the right ear of the virtual listener; and
a fourth attenuator to attenuate the signal delayed by the fourth delay unit by a fourth magnitude corresponding to the distance between the second virtual sound source and the left ear of the virtual listener.

15. The apparatus of claim 13, further comprising:
a third filter to filter out a high-frequency band of the signal delayed by the third delay unit to simulate high-frequency attenuation caused by diffraction at the head of the virtual listener; and
a fourth filter to filter out a high-frequency band of the signal delayed by the fourth delay unit to simulate high-frequency attenuation caused by the diffraction at the head of the virtual listener.

16. The apparatus of claim 13, further comprising:
a first adder to add the signal delayed by the fourth delay unit to the signal delayed by the first delay unit; and
a second adder to add the signal delayed by the third delay unit to the signal delayed by the second delay unit.

17. The apparatus of claim 16, further comprising:
a first filter to filter a high-frequency band of the signal output by the first adder to simulate high-frequency attenuation accompanying sound wave propagation through the air from the first virtual sound source to the left ear of the virtual listener; and
a second filter to filter a high-frequency band of the signal added by the second adder to simulate high-frequency attenuation accompanying sound wave propagation through the air from the second virtual sound source to the right ear of the virtual listener.

18. The apparatus of claim 16, further comprising:
a fifth delay unit to delay the signal output by the first adder for a fifth time period corresponding to a distance between the first virtual sound source and a first reflection surface and a distance between the first reflection surface and the left ear of the virtual listener;
a third adder to add the signal delayed by the fifth delay unit to the first input signal;
a sixth delay unit to delay the signal output by the second adder for a sixth time period corresponding to a distance between the second virtual sound source and a second reflection surface and a distance between the second reflection surface and the right ear of the virtual listener; and
a fourth adder to add the signal delayed by the sixth delay unit to the second input signal.

19. The apparatus of claim 18, wherein:
the first delay unit is a delay filter having a transfer function of HLL(z)=Z^{-M}_{LL}; the second delay unit is a delay filter having a transfer function of HRR(z)=Z^{-M}_{RR};
the third delay unit is a delay filter having a transfer function of HLR(z)=Z^{-M}_{LR}; the fourth delay unit is a delay filter having a transfer function of HRL(z)=Z^{-M}_{RL};
the fifth delay unit is a delay filter having a transfer function of HLLS/LRS(z)=Z^{-M}_{LLS/LRS}; and
the sixth delay unit is a delay filter having a transfer function of HRRS/RLS(z)=Z^{-M}_{RRS/RLS}.

20. The apparatus of claim 17, wherein:
the first filter is a low-pass filter; and
the second filter is a low-pass filter.

21. An apparatus to generate a virtual 3-dimensional (3D) sound from a first input signal and a second input signal, comprising:
a first processing unit to process a first input signal;
a second processing unit to process a second input signal;
a third processing unit to process the first input signal to be added to the processed second input signal as a second final signal; and
a fourth processing unit to process the second input signal to be added to the processed first input signal as a first final signal.

22. The apparatus of claim 21, wherein the first final signal corresponds to a first headphone for a left ear and the second final signal corresponds to a second headphone for a right ear.

23. The apparatus of claim 21, further comprising:
a first adder to add the first input signal processed by the third processing unit to the second input signal to generate the second final signal; and
a second adder to add the second input signal processed by the fourth processing unit to the processed first input signal to generate the first final signal.

24. The apparatus of claim 21, further comprising:
a fifth processing unit to process the first final signal to generate a processed first final signal; and
a sixth processing unit to process the second final signal to generate a processed second final signal.

25. The apparatus of claim 24, further comprising:
a reverberant sound generator to process the first final signal processed by the fifth processing unit to be added to the first final signal to gnerate a left 3D sound signal, and to process the second final signal processed by the sixth processing unit to be added to the second final signal to generate a right 3D sound signal.

26. The apparatus of claim 25, further comprising:
a third adder to add the first final signal processed by the fifth processing unit to the first input signal; and
a fourth adder to add the second final signal processed by the sixth processing unit to the second input signal.

27. The apparatus of claim 24, wherein:
the first processing unit processes the first input signal by delaying the first input signal for an amount of time corresponding to a distance between a first virtual sound source and the left ear of a virtual listener and attenuating the delayed first input signal;
the second processing unit processes the second input signal by delaying the second input signal for an amount of time corresponding to a distance between a second virtual sound source and the right ear of a virtual listener and attenuating the delayed second input signal;
the third processing unit processes the first input signal by delaying the first input signal for an amount of time corresponding to a distance between the first virtual sound source and the right ear of the virtual listener and attenuating the delayed first input signal; and
the fourth processing unit processes the second input signal by delaying the first input signal for an amount of time corresponding to a distance between the second virtual sound source and the left ear of the virtual listener.

28. The apparatus of claim 27, wherein:
the fifth processing unit processes the first final signal by delaying the first final signal by an amount of time corresponding to a distance between the first virtual source and a first reflection surface and a distance between the first reflection surface and the left ear of the virtual listener; and
the sixth processing unit processes the second final signal by delaying the second final signal by an amount of time corresponding to a distance between the second virtual sound source and a second reflection surface and a distance between the second reflection surface and the right ear of the virtual listener.

29. A method of generating virtual 3-dimensional (3D) sound from a first input signal and a second input signal, comprising:
processing a first input signal by a first processing operation;
processing a second input signal by a second processing operation;
processing the first input signal by a third processing operation;
processing the second input signal by a fourth processing operation;
adding the signal processed by the fourth processing operation to the signal processed by the first processing operation to generate a first final signal; and
adding the signal processed by the third processing operation to the signal processed by the second processing operation to generate a second final signal.

30. The method of claim 29, wherein:
the first processing operation delays the first input signal for an amount of time corresponding to a distance between a first virtual sound source and the left ear of a virtual listener and attenuating the delayed first input signal;
the second processing operation delays the second input signal for an amount of time corresponding to a distance between a second virtual sound source and the right ear of a virtual listener and attenuating the delayed second input signal;
the third processing operation delays the first input signal for an amount of time corresponding to a distance between the first virtual sound source and the right ear of the virtual listener and attenuating the delayed first input signal; and
the fourth processing operation delays the first input signal for an amount of time corresponding to a distance between the second virtual sound source and the left ear of the virtual listener.

31. The method of claim 29, further comprising:
processing the first final signal to generate a processed first final signal; and
processing the second final signal to generate a processed second final signal.

32. The method of claim 31, further comprising:
processing and adding the processed first final signal to the first final signal according to a fifth processing operation to generate a left 3D sound signal; and
processing and adding the processed second final signal to the second final signal according to a sixth processing operation to generate a right 3D sound signal.

33. The method of claim 32, wherein:
the fifth processing operation delays the first final signal for a fifth time period corresponding to a distance between the first virtual sound source and a first reflection surface and a distance between the first reflection surface and the left ear of the virtual listener; and
the sixth processing operation delays the second final signal for a sixth time period corresponding to a distance between the second virtual sound source and a second reflection surface and a distance between the second reflection surface and the right ear of the virtual listener.

34. The method of claim 33, wherein the first time period, the second time period, the third time period, the fourth time period, the fifth time period, and the sixth time period are all different from each other due to geometrical asymmetry in the positioning of the first and second virtual sound sources with respect to the virtual listener.

35. A computer-readable recording medium having recorded thereon a computer program to perform a method of generating virtual 3-dimensional (3D) sound from at least one signal, the method comprising:
delaying the signals for time periods corresponding to distances between at least one virtual sound sources and the left and right ears of a virtual listener.

36. A computer-readable recording medium having recorded thereon a computer program to perform a method of generating virtual 3-dimensional (3D) sound from a first input signal and a second input signal, the method comprising:
delaying the first input signal for a first time period corresponding to a distance between a first virtual sound source and the left ear of a virtual listener; and
delaying the second input signal for a second time period corresponding to a distance between a second virtual sound source and the right ear of the virtual listener.

37. A computer-readable recording medium having recorded thereon a computer program to perform a method of generating virtual 3-dimensional (3D) sound from a first input signal and a second input signal, comprising:
processing a first input signal by a first processing operation;
processing a second input signal by a second processing operation;
processing the first input signal by a third processing operation;
processing the second input signal by a fourth processing operation;
adding the signal processed by the fourth processing operation to the signal processed. by the first processing operation to generate a first final signal; and
adding the signal processed by the third processing operation to the signal processed by the second processing operation to generate a second final signal.
